(19) United States
(12) Patent Application Publication
(10) Pub. No.: US 2020/0024113 A1
(43) Pub. Date: Jan. 23, 2020

(54) CAR JACK

(71) Applicant: OPENAXIS S.R.L., Piobesi Torinese (TO) (IT)

(72) Inventor: Lino BRASOLA, Torino (IT)

(21) Appl. No.: 16/082,240

(22) PCT Filed: Mar. 3, 2017
(86) PCT No.: PCT/IB2017/051247

§ 371 Date: Sep. 4, 2018

(30) Foreign Application Priority Data
Mar. 4, 2016 (IT) 102016000023140

(51) Int. Cl. B66F 3/12

(52) U.S. Cl. CPC B66F 3/12

(57) ABSTRACT

A car jack includes a first pair of arms (1, 2) with each arm (1, 2) having a first end hinged to an upper striker (6); and a second pair of arms (3, 4) with each arm (3, 4) having a first end hinged to a lower striker (8), and a second end constrained, with freedom to rotate, to a second end of an arm belonging to the first pair of arms (1, 2). An actuator (10) moves closer/apart the points where the first pair of arms (1, 2) is constrained, in rotation, to the second pair of arms (3, 4), to adjust the distance between the upper striker (6) and the lower striker (8). The arms (1, 2, 3, 4) and the strikers (6, 8) are made of a plastic material.

### TECHNICAL FIELD

The invention relates to a car jack. Said car jack is portable and can be stored in the vehicle, and it can be used by the user in order to carry out ordinary maintenance operations, such as for example replacing a tyre of a vehicle.

### TECHNOLOGICAL BACKGROUND

A known type of car jack comprises: four arms, wherein a first pair of arms is hinged to an upper striker and to a second pair of arms, said second pair of arms being further hinged to a lower striker; an actuator, which is usually obtained by means of a screw and nut screw and is designed to move closer/apart the hinge points in order to adjust the distance between said upper striker and said lower striker. The lower striker rests against the ground and the upper striker rests against the vehicle, for example against the lower part of the body. Therefore, by manually acting upon the actuator, you can lift and lower the vehicle, so as to carry out mechanical repairs, such as for example replacing a tyre. These car jacks are made of metal, usually steel.

However, this type of car jacks suffers from some drawbacks.

A drawback lies in the fact that these car jacks are heavy and have numerous components.

A further drawback lies in the fact that the manufacturing process is energetically expensive and requires a lot of time, as many processing steps are needed. Furthermore, ferrous material require a protection from atmospheric agents, usually galvanizing or cataphoresis or phosphate coatings, which have a high environmental impact. Hence, the manufacturing process is expensive and environmentally harmful.

### SUMMARY OF THE INVENTION

An object of the invention is to provide a car jack which is able to solve this and other drawbacks of the prior art and which, at the same time, can be produced in a simple and economic fashion.

In particular, a further object of the invention is to provide a lighter car jack.

In particular, a further object of the invention is to provide a car jack with a reduced number of components.

According to the present invention, this and other objects are reached by means of a car jack having the features set forth in the appended independent claim.

A further object of the invention is to provide a kit to assemble a car jack.

The appended claims are an integral part of the technical teaches provided in the following detailed description concerning the invention. In particular, the appended dependent claims define some preferred embodiments of the invention and describe optional technical features thereof.

### BRIEF DESCRIPTION OF THE DRAWINGS

Further features and advantages of the invention will be best understood upon perusal of the following detailed description, which is provided by way of example and is not limiting, with reference to the accompanying drawings, which specifically show what follows:

FIG. 1 is a perspective view of a car jack according to an explanatory embodiment of the invention;

FIG. 2 is an exploded view of the car jack shown in FIG. 1;

FIG. 3 is a plan view of the car jack shown in FIG. 1;

FIG. 4 is a front view of the car jack shown in FIG. 1 in an extended condition;

FIG. 5 is a front view of the car jack shown in FIG. 1 in an contracted condition;

FIG. 6 is a side view of the car jack shown in FIG. 1;

FIG. 7 is an exploded view of a car jack according to a further explanatory embodiment of the invention;

FIG. 8 is a perspective view of a particular type of arm of the car jack;

FIG. 9 is a front cross section of the car jack shown in FIG. 7.

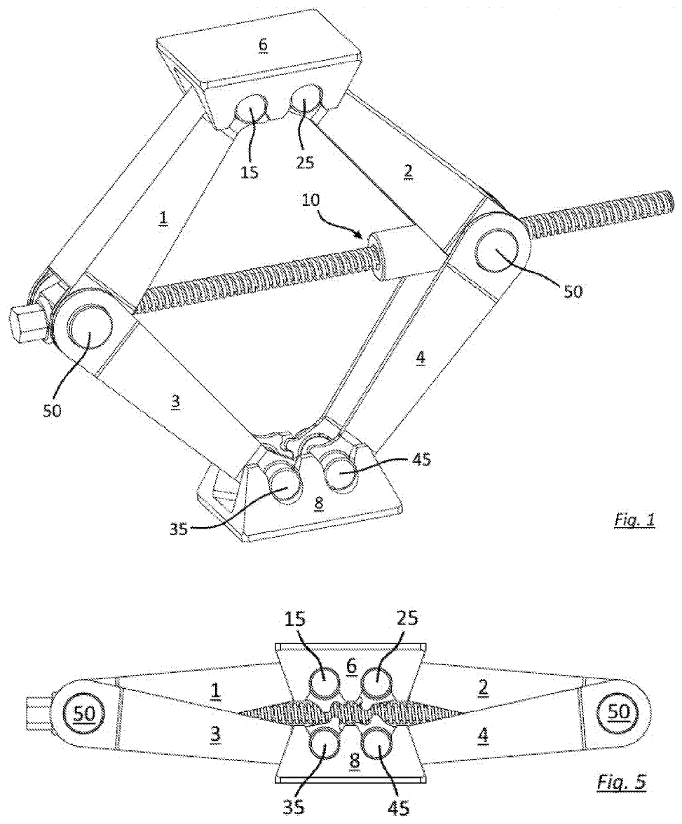

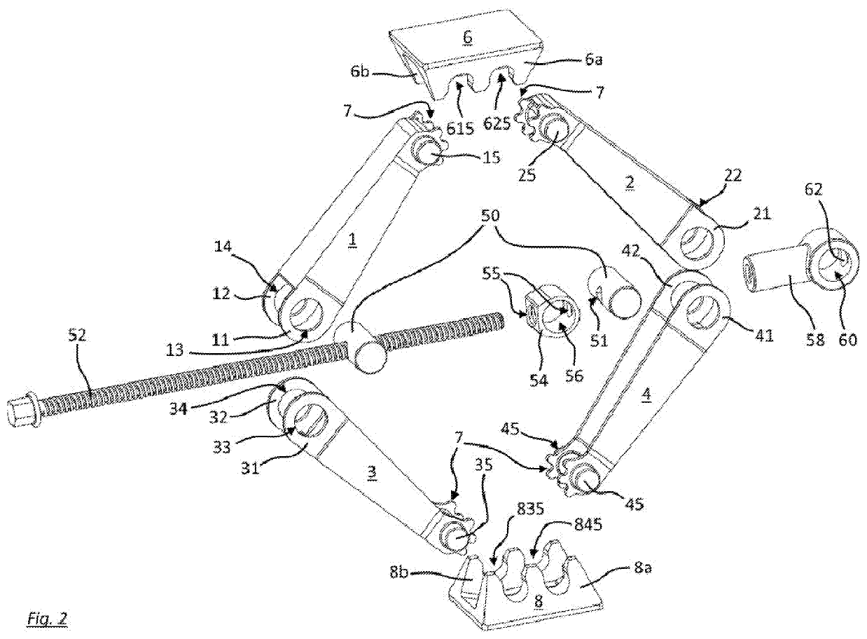

### DETAILED DESCRIPTION OF THE INVENTION

With reference to the figures, the car jack comprises:

a first pair of arms 1, 2, wherein each arm 1, 2 has a first end hinged to an upper striker 6;

a second pair of arms 3, 4, wherein each arm 3, 4 has a first end hinged to a lower striker 8, and a second end constrained, with freedom to rotate, to a second end of an arm belonging to said first pair of arms 1, 2;

an actuator 10 for moving closer/apart the points where said first pair of arms 1, 2 is constrained, in rotation, to said second pair of arms 3, 4, so as to adjust the distance between said upper striker 6 and said lower striker 8.

According to an embodiment that is not shown herein, an arm 1 belonging to the first pair of arms 1, 2 and an arm 3 belonging to the second pair of arms 3, 4 are hinged to a first side striker portion (similarly to how the arms 1 and 2 are hinged to the upper striker 6). The arms 2 and 4 are constrained in a similar manner. The actuator 10 acts by moving apart/closer the two side striker portions. The arms 1-4 have a configuration that substantially has the shape of a rhombus or of a pantograph.

Preferably, the arms 1, 2, 3, 4 have the same shape. By so doing, the car jack can be produced in a quicker and more economic fashion, as the number of pieces with a different shape is reduced.

With reference to the preferred embodiment shown herein, the first pair of arms 1, 2 is hinged to upper striker 6 and to the second pair of arms 3, 4, said second pair of arms 3, 4 being further hinged to the lower striker 8. In particular, the second ends of the first pair of arms 1, 2 are respectively hinged to the second ends of the second pair of arms 3, 4.

The actuator 10 is designed to move closer/apart the two hinge points where the first pair of arms 1, 2 is hinged to the second pair of arms 3, 4, so as to adjust the distance between the upper striker 6 and the lower striker 8.

The arms 1, 2, 3, 4 and the strikers 6, 8 are made of a plastic material. Said plastic material preferably is a polymer, such as for example polyamide, preferably with the addition of mineral fillers and/or composite materials. The plastic material allows a more energetically efficient and quicker manufacturing process, hence the car jack can be produced generating a reduced environmental impact and in shorter times. Conveniently, the arms 1, 2, 3, 4 and the strikers 6, 8 are manufactured by means of moulding.

The actuator 10 preferably is a linear actuator connected to the two hinge points where the first pair of arms 1, 2 is hinged to the second pair of arms 3, 4.

Preferably, in a pair of arms 1, 2, the first end of the arm 1 has teeth 7 in mutual meshing with the teeth 7 of the first end of the other arm 2. Similarly, the second pair of arms 3, 4 also has mutually meshing teeth 7 at the respective first ends. The number of teeth 7 is suited to ensure a good meshing between the ends of the pairs or arms.

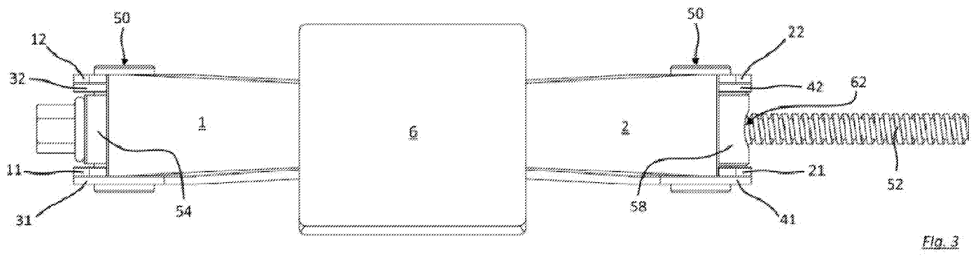

In the area of the hinge points, each arm 1-4 comprises, on its second end, two flanges 11, 12, 21, 22, 31, 32, 41, 42 provided with a respective hole 13, 14, 33, 34 housing a through pin 50. In order to make the figures graphically simpler, they show the holes 13, 14, 33, 34 belonging to the arms 1 and 3. The through pins 50 define the hinge points. With special reference to FIG. 3, in the area of the hinge points on the second ends, the flanges 11, 12 of an arm 1 alternate with the flanges 31, 32 of the other arm 2 along the axis of the through pin 50. The axis of the through pin 50 is transverse to the longitudinal axis of the arms 1-4. Therefore, with reference to the arms 1 and 2, when moving along the axis of the through pin 50, you meet in sequence the flanges 31, 11, 32, 12. Similarly, with reference to the arms 3 and 4, when moving along the axis of the through pin 50, you meet in sequence the flanges 41, 21, 42, 22. This alternation of the flanges allows a preferred variant of the car jack in which the four arms 1-4 have the same shape. By so doing, manufacturing costs and times can be reduced, thus producing one single type of arms capable of making up the car jack. The through pins 50 are preferably made of a plastic material and, in particular, they can be made of the same plastic material as the arms 1-4 and the strikers 6, 8.

The through pins 50 is designed so as to be easily inserted into and removed from the holes 13, 14, 33, 34 of the respective flanges 11, 12, 21, 22, 31, 32, 41, 42. Optionally, the car jack comprises holding means 39, which can be known, such as for example a split pin, so as to prevent the through pin 50 from accidentally moving out of the holes 13, 14, 33, 34.

With reference to the preferred embodiment shown herein, the actuator 10 comprises:

a screw 52, housed in a support 54 having a through hole 56, where the through pin 50 is housed; and

a nut screw 58 having a through hole 60, where the other through pin 50 is housed.

The through pins 50 have a passage 51, where the screw can slide. The nut screw 58 has a bottom opening 62, which is made on the walls that define the through hole 60, so as to allow the passage of the screw 52. The support 54 includes through openings 55, where the screw 52 can slide.

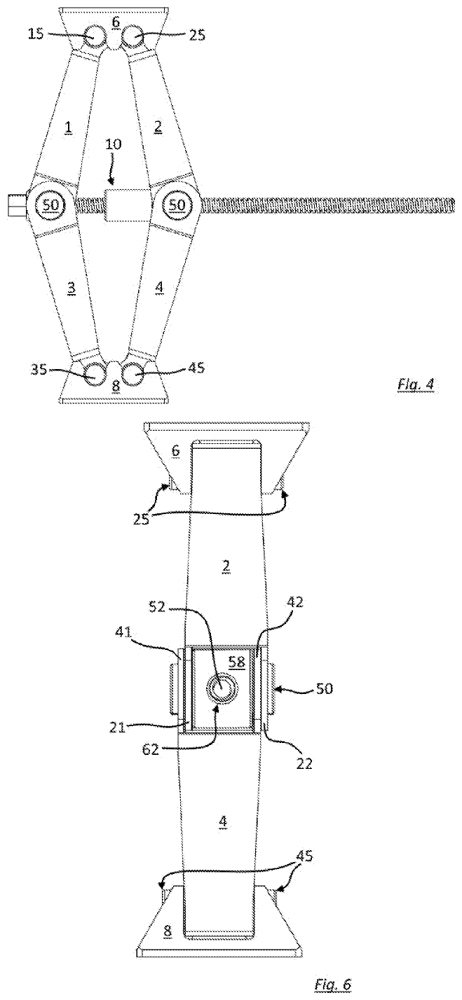

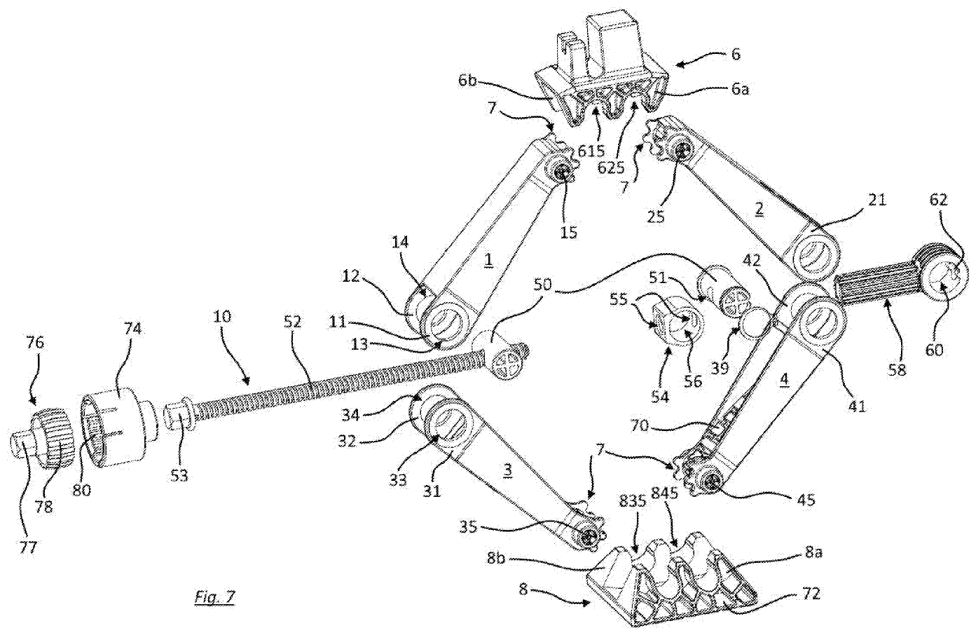

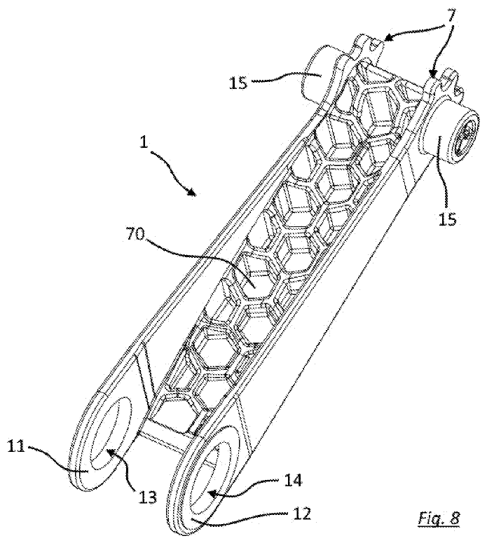

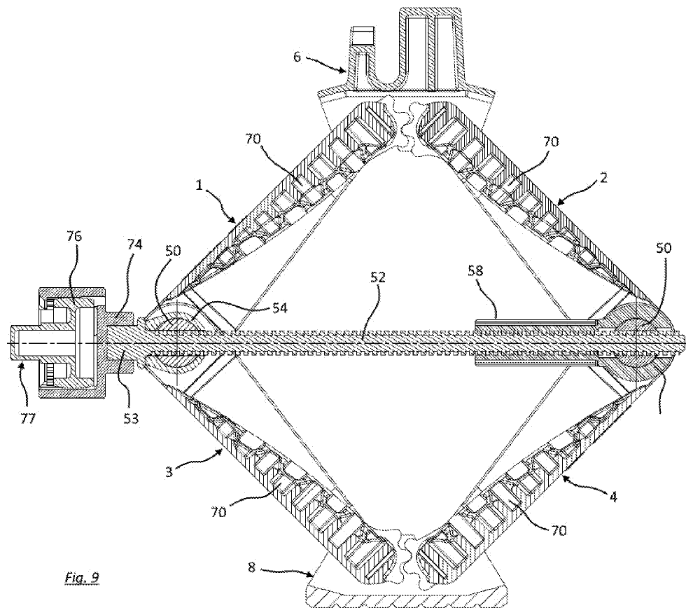

Therefore, the support 54 and the nut screw 58 are fixed to the hinge points and the user, by acting upon the screw 52, moves the hinge points apart/closer, thus adjusting the distance between the upper striker 6 and the lower striker 8. Hence, the car jack can move from an extended condition, shown in FIG. 4, to a contracted condition, shown in FIG. 5. The upper striker 6 is designed to rest against a portion of the vehicle, for example the lower part of the body, and the lower striker 8 is designed to rest against the ground.

Conveniently, the support 54 is made of acetal resin. Preferably, the through pin 50 is made of a plastic material, in particular polyamide, for example with the addition of mineral fillers and/or composite materials. Conveniently, the nut screw 58 is made of acetal resin.

Preferably, the upper striker 6 or the lower striker 8 is constrained, through a spherical hinge, to a support portion designed to rest against the ground or the vehicle. By so doing, the car jack can be better adjusted to the inclination of the surfaces with which it comes into contact. Optionally, both strikers 6, 8 are constrained to a respective support portion.

Preferably, each arm 1-4 has, at an end of it, a cylindrical or possibly half-cylindrical portion, which is transverse to the axis of the arm itself and is designed to engage, in a removable manner, a corresponding seat 615, 625, 835, 845 of said strikers 6, 8. The cylindrical portion is shaped so as to allow the arm 1-4 to rotate in the striker 6, 8 on which it is pivoted. Preferably, the cylindrical portion is manufactured as one single body together with the respective arm 1-4.

Conveniently, the cylindrical portion can be inserted into the respective seat 615, 625, 835, 845 through a snap mechanism. The seat 615, 625, 835, 845 has an initial narrowing, which is such that the cylindrical portion is inserted into the respective seat by exerting a force that is sufficient to move past said narrowing. Hence, assembling the car jack turns out to be even simpler and quicker.

In particular, the cylindrical portion includes a pair of cylindrical ends 15, 25, 35, 45, which transversely project from the respective arm 1-4. The cylindrical ends 15, 25, 35, 45 are substantially pin-shaped so as to be inserted into the respective seat 615, 625, 835, 845. In particular, the upper striker 6 and/or the lower striker 8 comprise a pair of ribs 6a, 6b, 8a, 8b having recesses that create the seat 615, 625, 835, 845. For example, the cylindrical portion of the arm 4 includes a pair of cylindrical ends 45, which are inserted into the respective seat 845. A first cylindrical end 45 is inserted into the recess of the rib 8a and a second cylindrical end 45 is inserted into the recess of the rib 8b. The seat 845 is created by a pair of recesses of the ribs 8a and 8b respectively.

The invention allows manufacturers to produce a car jack that advantageously has a minimum number of components, thus making it easy to be manufactured, light and economic.

According to the invention, there is also provided a kit to assemble a car jack, said kit comprising:

a first pair of arms 1, 2,

a second pair of arms 3, 4,

an upper striker 6,

a lower striker 8,

wherein each arm of the first pair of arms 1, 2 has a first end for being hinged to the upper striker 6; each arm of the second pair of arms 3, 4 has a first end for being hinged to a lower striker 8, and a second end for being constrained, with freedom to rotate, to a second end of an arm belonging to said first pair of arms 1, 2;

an actuator 10 for moving closer/apart the points where said the pair of arms 1, 2 is designed to be constrained, with freedom to rotate, to the second pair of arms 3, 4, so as to adjust the distance between the upper striker 6 and the lower striker 8.

One of the advantages of the kit lies in the possibility of assembling the car jack in a place different from the moulding site, so as to optimize transportation and logistics.

The arms 1, 2, 3, 4 and the strikers 6, 8 are made of a plastic material. The kit can advantageously comprise the functional and structural features of the car jack described above, which, for the sake of brevity, will not be repeated below, though without going beyond the scope of protection of the invention.

According to a different embodiment, the car jack has four arms 1, 2, 3, 4 having the same shape, wherein said arms 1, 2, 3, 4 and the strikers 6, 8 are made of a material other than plastic. For example, these elements are made of a metal, such as steel. The arms 1, 2 are hinged to the arms 3, 4. Similarly to what described above, in the area of the hinge points, each arm 1-4 comprises, on an end of it, two flanges 11, 12, 21, 22, 31, 32, 41, 42 provided with a respective hole 13, 14, 33, 34 housing the through pin 50. The through pins 50 define the hinge points. With special reference to FIG. 3, in the area of the hinge points, the flanges 11, 12 of an arm 1 alternate with the flanges 31, 32 of the other arm 2 along the axis of the through pin 50. It is also possible to provide a kit to assemble a car jack of this type. Except for the material, this embodiment of the car jack can advantageously comprise the functional and structural features of the car jack described above, which, for the sake of brevity, will not be repeated.

According to a variant of the invention, the arms 1, 2, 3, 4 are at least partially made with a honeycomb structure. As you can see, there are open cells 70 with an hexagonal shape. The honeycomb structure is manufactured together with the arms, for example by means of moulding or injection moulding. In particular, the honeycomb structure extends between the two ends of each arm 1, 2, 3, 4. The honeycomb structure ensures a significant increase in the mechanical resistance of the arms, though reducing their weight and costs. As a matter of fact, by mere way of non-limiting example, the car jack can lift at least 1400 kg.

Preferably, the honeycomb structure is obtained on a central core of the arm and, in particular, on the face of the core facing the inside of the quadrilateral formed by the car jack.

With reference to the cross-section, the central core of the arm 1, 2, 3, 4 has a variable thickness between the first and the second end of said arm. Preferably, the central core of each arm is thicker in the area of the upper striker 6 or of the lower striker 8, respectively. By so doing, the resistance/weight ratio can be further increased.

Preferably, at least one between the upper striker 6 and the lower striker 8 has a plurality of open structural cells 72. By so doing, the resistance/weight ratio can be further increased.

Preferably, the actuator 10 comprises a screw 52 cooperating with a nut screw 58. Said screw 52 and nut screw 58 are mounted in the points where the first pair of arms 1, 2 is fitted to the second pair of arms 3, 4.

Preferably, the car jack comprises:

a fixed portion 74, which is integral in its rotation to the screw 52,

a rotary portion 76, which is designed to be rotated by a user and is constrained to the fixed portion 74 in such a way that, when the torque exerted upon said rotary portion 76 remains below a threshold value, the fixed portion 74 and the rotary portion 76 are constrained in rotation and, when the exerted torque reaches the threshold value, the rotary portion 76 rotates relative to the fixed portion 74.

Hence, the two portions 74, 75 create a clutch that is capable of limiting the torque transmitted to the screw 52. By so doing, the car jack can be prevented from breaking due to an illegitimate use thereof, thus ensuring the safety of the user. Conveniently, the user can rotate the rotary portion 76 by means of a tool, such as a wrench. For example, the rotary portion 76 has a hexagonal head 77, similar to the head of a screw, upon which the user can act with a tool.

In particular, the fixed portion 74 and the rotary portion 76 have mutual engagement portions, which are designed to forbid or enable the mutual rotation between the rotary portion 76 and the fixed portion 74, depending on the torque applied to the rotary portion 76. With reference to the example shown, the rotary portion 76 and the fixed portion 74 are circular and concentric. In the example, the rotary portion 76 is radially arranged on the inside of the fixed portion 74. The fixed portion 74 is—in the example—a distinct element from the screw 52; however, it 74 can be an integral part of the screw 52. In particular, the fixed portion 74 is designed be engaged by the head 53 of the screw 52; for example, the fixed portion 74 defines a cavity, which is designed to be engaged by the head 53 of the screw 52, thus constraining in rotation the fixed portion 74 and the screw 52.

In particular, the engagement surfaces of the rotary portion 76 and of the fixed portion 74 are friction surfaces, in particular they have a knurling or the like. Therefore, when the torque remains below the threshold value, said engagement surfaces keep the rotary portion 76 and the fixed portion 74 constrained in rotation; on the other hand, when the torque exceeds the threshold value, the rotary portion 76 rotates relative to the fixed portion 74. In particular, a first engagement surface 78 is obtained on a radially outer face of the rotary portion 76 and a second engagement surface 80 is obtained on an radially inner face of the fixed portion 74. According to a further optional variant, a clutch like the one described above can be also applied to another car jack made of any other material.

Preferably, one between the rotary portion 76 and the fixed portion 74 is elastically deformable. For example, the fixed portion 74 has one or more cuts to increase its ability to deform.

Preferably, all the elements of the car jack are made of a plastic material. The screw 52, the rotary portion 76 or the fixed portion 74 cannot be made of a plastic material.

Naturally, the principle of the invention being set forth, embodiments and implementation details can be widely changed relative to what described above and shown in the drawings as a mere way of non-limiting example, without in this way going beyond the scope of protection provided by the accompanying claims.

1. A car jack comprising:
a first pair of arms, wherein each arm of the first pair of arms has a first end hinged to an upper striker;
a second pair of arms, wherein each arm of the second pair of arms has a first end hinged to a lower striker, and a second end constrained, with freedom to rotate, to a second end of an arm belonging to said first pair of arms;
an actuator for moving closer/apart the points where said first pair of arms is constrained, in rotation, to said second pair of arms, to adjust a distance between said upper striker and said lower striker;
wherein said arms and said strikers are made of a polymer.

2. The car jack according to claim 1, wherein said first pair of arms is hinged to said second pair of arms at the respective second ends, and said actuator moves closer/apart hinge points where said first pair of arms is hinged to said second pair of arms.

3. The car jack according to claim 2, wherein, at said hinge points, each arm comprises, on the second end, two flanges provided with a respective hole housing a through pin.

4. The car jack according to claim 3, wherein, at said hinge points, the flanges of an arm alternate with the flanges of the other arm along an axis of said through pin.

5. The car jack according to claim 4, wherein said four arms have a same shape.

6. The car jack according to claim 1, wherein each arm has, at an end, a cylindrical portion, which is transverse to the axis of the arm and removably engages a corresponding seat of said strikers.

7. The car jack according to claim 6, wherein said cylindrical portion includes a pair of cylindrical ends, which transversely project from the respective arm.

8. The car jack according to claim 6, wherein said cylindrical portion is insertable into the respective seat through a snap mechanism.

9. The car jack according to claim 3, wherein said actuator comprises:
a screw, housed in a support having a through hole, where said through pin is housed; and
a nut screw having a through hole, where said through pin is housed.

10. The car jack according to claim 1, wherein said upper striker or said lower striker is constrained, through a spherical hinge, to a support portion configured to rest against the ground or the vehicle.

11. The car jack according to claim 3 comprising holding means to prevent said through pin from accidentally moving out of said holes of said arms.

12. The car jack according to claim 1, wherein said plastic material is polyamide, with added mineral fillers and/or composite materials.

13. The car jack according to claim 1, wherein the arms are at least partially made with a honeycomb structure.

14. The car jack according to claim 13, wherein the honeycomb structure extends between the two ends of each arm.

15. The car jack according to claim 13, wherein at least one between the upper striker and the lower striker has a plurality of open structural cells.

16. The car jack according to claim 1, wherein the actuator comprises a screw cooperating with a nut screw, and the car jack comprises:
a fixed portion, which integrally rotates with the screw,
a rotary portion, which is rotatable by a user and is constrained to the fixed portion in such a way that, when torque exerted upon said rotary portion remains below a threshold value, the fixed portion and the rotary portion are constrained in rotation and, when the exerted torque reaches the threshold value, the rotary portion rotates relative to the fixed portion.

17. The car jack according to claim 16, wherein the fixed portion and the rotary portion have mutual engagement portions, which to forbid or enable mutual rotation between the rotary portion and the fixed portion, depending on the torque applied to the rotary portion.

18. The car jack according to claim 1, wherein the central core of the arm has a variable thickness between the first end and the second end of said arm.

19. A kit to assemble a car jack, said kit comprising:
a first pair of arms,
a second pair of arms,
an upper striker,
a lower striker,
wherein each arm of the first pair of arms has a first end hinged to the upper striker; each arm of the second pair of arms has a first end hinged to a lower striker, and a second end for being constrained, with freedom to rotate, to a second end of an arm belonging to said first pair of arms;
an actuator for moving closer/apart the points where said first pair of arms is constrained, with freedom to rotate, to said second pair of arms, so as to adjust a distance between said upper striker and said lower striker; wherein said arms and said strikers are made of a plastic material.

20. The kit according to claim 19, wherein said plastic material is polyamide, with added mineral fillers and/or composite materials.
